(19) United States
(12) Patent Application Publication
(10) Pub. No.: US 2015/0231944 A1
(43) Pub. Date: Aug. 20, 2015

(54) PNEUMATIC SPRING SYSTEM INCORPORATING OVERLOAD DETECTION

(71) Applicants: Holger Oldenettel, Wedemark (DE); Christopher William Olsen, Royal Oak, MI (US); Satish Nandkumar Panse, Clawson, MI (US); Gary Allan Gonzales, Northville, MI (US)

(72) Inventors: Holger Oldenettel, Wedemark (DE); Christopher William Olsen, Royal Oak, MI (US); Satish Nandkumar Panse, Clawson, MI (US); Gary Allan Gonzales, Northville, MI (US)

(73) Assignees: Continental Teves AG & Co. oHG, Frankfurt (DE); Chrysler Group LLC, Auburn Hills, MI (US)

(21) Appl. No.: 14/414,769

(22) PCT Filed: Jul. 19, 2012
(86) PCT No.: PCT/US2012/047358

§ 371 Date: Apr. 27, 2015

(51) Int. Cl. B60G 17/015; B60G 17/052; B60G 17/017

(52) U.S. Cl. CPC B60G 17/0155; B60G 17/017; B60G 17/0525; B60G 2202/152; B60G 2400/51222; B60G 2400/61; B60G 2500/202; B60G 2500/302

(57) ABSTRACT

A computer-implemented method for monitoring a load on a rear axle and/or a front axle of a chassis, wherein a level control system raises the chassis to a predetermined level by a raising operation after a loading operation and/or after an alteration in a level of the chassis, wherein the method includes the following steps: determination of the load on the rear axle and/or the front axle of the chassis, wherein determination is performed continuously after initiation of the raising operation; comparison of the load determined with a predefined limiting value; and adaptation of the raising operation if the limiting value is exceeded or undershot.

### CROSS REFERENCE TO RELATED APPLICATIONS

This application is the national phase application of PCT/US2012/047358, filed Jul. 19, 2012, the contents of this application being incorporated by reference herein.

### FIELD OF THE INVENTION

The invention relates to a method for detecting an overload on vehicle axles on vehicles having a pneumatic spring system.

### BACKGROUND OF THE INVENTION

On vehicles having pneumatic spring systems, the height of the body is automatically adjusted during loading. In contrast to conventional steel springs, the vehicle does not sag, even when overloaded. Owing to the absence of optical feedback, there is therefore an increased risk that the driver will load the vehicle even beyond the permissible axle load. As a result, there may be damage both to the pneumatic springs and to other vehicle components, such as the tyres and/or the axle.

The prior art includes a method for determining a wheel contact force of a motor vehicle wheel during a level control operation, said method being disclosed in DE 10 2005 023 654 A1, which is incorporated by reference.

Given this background, it is the underlying object of the invention to provide an improved method for detecting an overload on vehicle axles on vehicles having a pneumatic spring system.

### SUMMARY OF THE INVENTION

An aspect of the invention provides a method for monitoring a load on a rear axle and/or a front axle of a chassis, wherein a level control system raises the chassis to a predetermined level by means of a raising operation after a loading operation and/or after an alteration in a level of the chassis, wherein the method comprises the following steps:
determination of the load on the rear axle and/or the front axle of the chassis, wherein determination is performed continuously after initiation of the raising operation,
comparison of the load determined with a predefined limiting value,
adaptation of the raising operation if the limiting value is exceeded or undershot.

This can have the advantage that any overloading of the rear axle and/or the front axle of a chassis of a vehicle is detected after a loading operation and/or an alteration in a level caused in some other way, and this overloading and/or incorrect level can be counteracted in a timely manner by means of an adaptation process triggered by the level control system. Determination of the load is carried out not just once, after initiation of the raising operation, but is performed continuously during the entire raising operation. Continuous determination of the load during the raising operation opens up the possibility, for example, of counteracting excessive upward adjustment of the level in an adequate and timely manner.

According to one embodiment of the invention, the predetermined level is a measurement level, wherein the measurement level is chosen in such a way that the chassis is raised from buffers of a pneumatic spring system, and wherein the determination of the load on the rear axle and/or the front axle of the chassis is carried out at this measurement level, wherein the level control system lowers the rear axle and/or the front axle as the adaptation of the raising operation if the load on the rear axle and/or the front axle of the chassis exceeds a predefined limiting value, wherein the level control system raises the rear axle and/or the front axle as the adaptation of the raising operation if the load on the rear axle and/or the front axle of the chassis undershoots the predefined limiting value.

Embodiments of the invention can have the advantage that determination of the weight of the payload takes place in a correct manner and without distortion, since there is no subtraction of weight due to the load being partially raised by counter forces from buffers.

In this context, the buffers form the additional springs installed in the pneumatic springs. A distinction is drawn here, in turn, between two types of additional spring: a) those which take effect just a few millimetres before the end of the stroke, referred to as “end stop buffers”, and b) springs which come into operation after about half of the compression travel. End stop buffers are used primarily in vehicles for transporting goods and prevent the piston and the plate of the pneumatic spring from coming into contact. Otherwise, they have no significant effect on the spring characteristic of the pneumatic spring.

Since, in the method described, the respective axle subjected to load is lowered and/or the axle which is not overloaded is raised if the load on the rear axle and/or the front axle of the chassis exceeds a predefined limiting value, the pneumatic spring system gives the driver optical feedback on the state of load of the chassis. The tilting of the vehicle makes the overloaded state of the chassis easily visible from outside, without even the need for an additional indication in the cockpit.

According to one embodiment of the invention, the determination of the load on the rear axle and/or the front axle of the chassis at the measurement level is performed by means of a measurement of a pressure in pneumatic springs of the pneumatic spring system, wherein the pressure is proportional to the load and allows calculation of a current load on the rear axle and/or the front axle of the chassis.

This can have the advantage that the functionality of the pneumatic spring system is expanded in an advantageous manner by integration of a measurement method that is proportional to the pressure. The driver receives information relevant to the system on the state of load of the chassis without being dependent on an external weighing machine. By virtue of the fact that this information is given independently of the location of the vehicle, the driver can make maximum use of the permissible axle load of the vehicle in any situation without being dependent on additional measuring instruments. Through immediate corrective measures to eliminate a state of overload of the chassis contrary to regulations, the driver can not only avoid potential fines for exceeding the permissible values for the axle load but can also significantly increase driving safety in an advantageous manner.

According to one embodiment of the invention, the determination of the load is carried out even in an initial phase of the raising operation by measuring the pressure in the pneumatic springs of the pneumatic spring system, and the raising of the level of the chassis is discontinued as the adaptation of the raising operation if a predefined limiting value for the load on the rear axle and/or the front axle of the chassis is exceeded.

This can have the advantage that an extreme overload on the chassis is detected at an early stage, before potential damage to the pneumatic springs. The load on the pneumatic springs is reduced in a preventive manner by discontinuing an upward adjustment operation on the chassis. A self-initiated self-regulating mechanism also prevents any damage to the pneumatic spring system and/or to other components of the chassis if the driver does not react to a warning.

According to one embodiment of the invention, the level control system initially lowers only the rear axle of the chassis if a first predefined limiting value for the load on the rear axle and/or the front axle of the chassis is exceeded.

This can have the advantage that the method described comprises a multi-stage warning system. In the case of moderate overloading, only the rear axle of the vehicle is lowered initially. The tilt indicates to the driver that the vehicle is overloaded.

According to one embodiment of the invention, the level control system raises the front axle if an at least second predefined limiting value for the load on the rear axle and/or the front axle of the chassis is exceeded.

The additional raising of the front axle ensures a more pronounced tilt of the chassis. This reinforces the optical indication for the driver. Here, the second predefined limiting value is greater than the first predefined limiting value.

According to one embodiment of the invention, the level control system lowers the front axle again when a predefined threshold value for a speed of the chassis is reached.

If the driver ignores the optical warning of the presence of a state of overload of the chassis and still drives the vehicle despite critical overloading of the vehicle axles and of the pneumatic spring system, the front axle is lowered when a predefined speed threshold is reached. This improves driving dynamics and reduces the risk to the driver.

According to one embodiment of the invention, an optical and/or acoustic warning signal is set if at least one of the limiting values for the load on the rear axle and/or the front axle of the chassis is exceeded.

This can have the advantage that additional information communication systems relating to a state of overload of the chassis are available to the driver. The probability that the driver will actually notice a warning is thus considerably increased. The probability that the driver will avoid overloading the vehicle through adequate countermeasures is thus likewise significantly increased. The probability that damage will be caused to the vehicle by overloading is reduced accordingly. Driving safety is increased.

According to one embodiment of the invention, the method for monitoring the load on the rear axle and/or the front axle of the chassis is activated manually and/or automatically.

Manual activation of the method for monitoring the load on the rear axle and/or the front axle of the chassis can have the advantage that the driver can determine the appropriate time for measuring the state of load of the chassis himself. If the vehicle is not loaded at all, activation of the overload detection system is not required. The vehicle is ready for operation immediately.

Where a vehicle is loaded on a regular basis, on the other hand, automatic activation of the method for monitoring the load on the rear axle and/or the front axle of the chassis is advantageous since, in this case, the driver is protected in an effective and preventive manner from possibly forgetting to switch on the overload detection system. The driver thus receives warning signals automatically on any possible state of overload of the loaded vehicle. Moreover, the self-regulating mechanisms that protect the vehicle and the driver, e.g. premature discontinuation of the upward adjustment operation and or the lowering of the front axle when a defined speed threshold is reached, are triggered automatically without the need for action by the driver. The occurrence of damage to the vehicle due to an overload is avoided and driving safety is increased.

According to one embodiment of the invention, the current load on the rear axle and/or the front axle of the chassis is indicated optically.

This can have the advantage that the driver can make full use of the permissible maximum values for the axle load in any loading situation. The real-time information on the current load on the rear axle and/or the front axle of the chassis may furthermore also make the driver use the vehicle in a manner appropriate to the respective state of load. In this way, an experienced driver will obtain indirect information on how fast it is possible to drive, on a bend for example, and/or in what way the vehicle must be braked in order to avoid impairing driving safety.

According to one embodiment of the invention, the determination of the load on the pneumatic spring system for the entire rear axle and/or the entire front axle is performed by just one pressure sensor.

This could have the advantage of eliminating the need for a pressure sensor on each individual pneumatic spring, which would in each case determine only the individual pressure of the respective pneumatic spring. During a raising operation, the pressure would thus not be monitored at each individual pneumatic spring but could instead be determined by a single “higher-level” pressure sensor centrally processing individual information on the individual pressures prevailing in the individual pneumatic springs. This pressure sensor could then also be positioned at a central point in the level control system, e.g. at the outlet of a compressor. Determining the load by means of just one pressure sensor allows continuous monitoring of the pressure during all phases of the raising operation.

According to another aspect, the invention relates to a computer program product which comprises instructions that can be executed by a processor and is intended for carrying out the method described above.

According to another aspect, the invention relates to a monitoring system for monitoring a load on a rear axle and/or a front axle of a chassis, which is designed to control a level control system in such a way after a loading operation and/or after checking of the level of the chassis that the chassis is raised to a measurement level, wherein the measurement level is chosen in such a way that the chassis is raised from buffers of a pneumatic spring system, and that determination of the load on the rear axle and/or the front axle of the chassis is carried out at this measurement level, wherein the level control system lowers the rear axle and/or raises the front axle if the load on the rear axle and/or the front axle of the chassis exceeds a predefined limiting value, said monitoring system comprising:
means for checking the level of the chassis,
means for raising the chassis to a measurement level at which the chassis is raised from buffers of the pneumatic spring system,
means for detecting the measurement level at which the chassis is raised from buffers of the pneumatic spring system,
means for measuring the pressure in the pneumatic springs of the pneumatic spring system,
means for calculating the current load on the rear axle and/or the front axle of the chassis,
means for indicating the current load on the rear axle and/or the front axle of the chassis,
means for raising and/or lowering the rear axle,
means for raising and/or lowering the front axle,
means for transmitting a warning signal,
means for manually and/or automatically activating the monitoring system for monitoring the load on the rear axle and/or the front axle of the chassis.

### BRIEF DESCRIPTION OF THE DRAWINGS

Preferred embodiments of the invention are explained in greater detail below with reference to the following drawings.

In the drawings:

FIG. 1 shows a pneumatic level control system having an integrated monitoring system for monitoring a load on vehicle axles,

FIG. 2 shows method steps of the method for monitoring a load on vehicle axles.

### DETAILED DESCRIPTION OF THE PREFERRED EMBODIMENTS

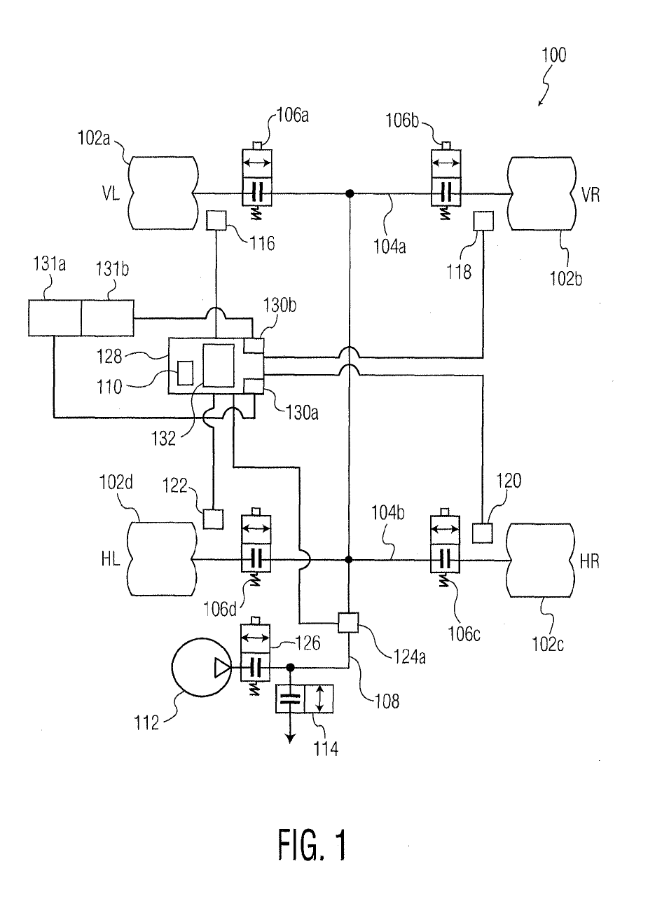

FIG. 1 shows a circuit of a pneumatic level control system having an integrated monitoring system for monitoring a load on vehicle axles.

The pneumatic level control system consists of the pneumatic springs 102a and 102b at the wheels of the front axle and the pneumatic springs 102d and 102c at the wheels of the rear axle. The crossflow shut-off valves 106a, 106b, 106d and 106c are inserted upstream of the pneumatic springs in order to allow or prevent a flow of compressed air in an air path to or from a pneumatic spring.

A compressor 112 produces the pressures required to operate the level control system. System air can be released from the pneumatic level control system to an external environment via the discharge valve 114. The vehicle level brought about by the pneumatic actuator system is measured by the level sensors 116, 118, 120 and 122. The output signals of the level sensors 116, 118, 120 and 122 are lead to a control unit 128. The control unit 128 comprises a processor 110, two calculation modules 130a, 130b and a memory 132.

The pressure sensor 124a measures the overall pressure of the air within the pneumatic spring system. The pressure sensor 124a measures the pressure in the pneumatic springs 102a, 102b, 102d and 102c at the wheels of the front and rear axles. The output signals of the pressure sensor 124a are lead to the control unit 128 as well. The pressure at the pneumatic springs of the rear axle, which is determined in the pressure sensor 124a, is used to calculate the weight of any payload present above the rear axle of the vehicle in a calculation module 130a for calculating the weight of said payload. The pressure at the pneumatic springs of the front axle, which is determined in the pressure sensor 124a, is used to calculate the weight of any payload present above the front axle of the vehicle in a calculation module 130b for calculating the weight of said payload.

The calculation module 130a for calculating the weight of the payload above the rear axle transfers the calculated result to an indicator unit 131a for indicating a current load on the rear axle. The calculation module 130b for calculating the weight of the payload above the front axle transfers the calculated result to an indicator unit 131b for indicating a current load on the front axle. The indicator units 131a and 131b can also send an indication of an optical warning signal or, on the other hand, a trigger signal to a device so that said device transmits an acoustic and/or optical warning signal.

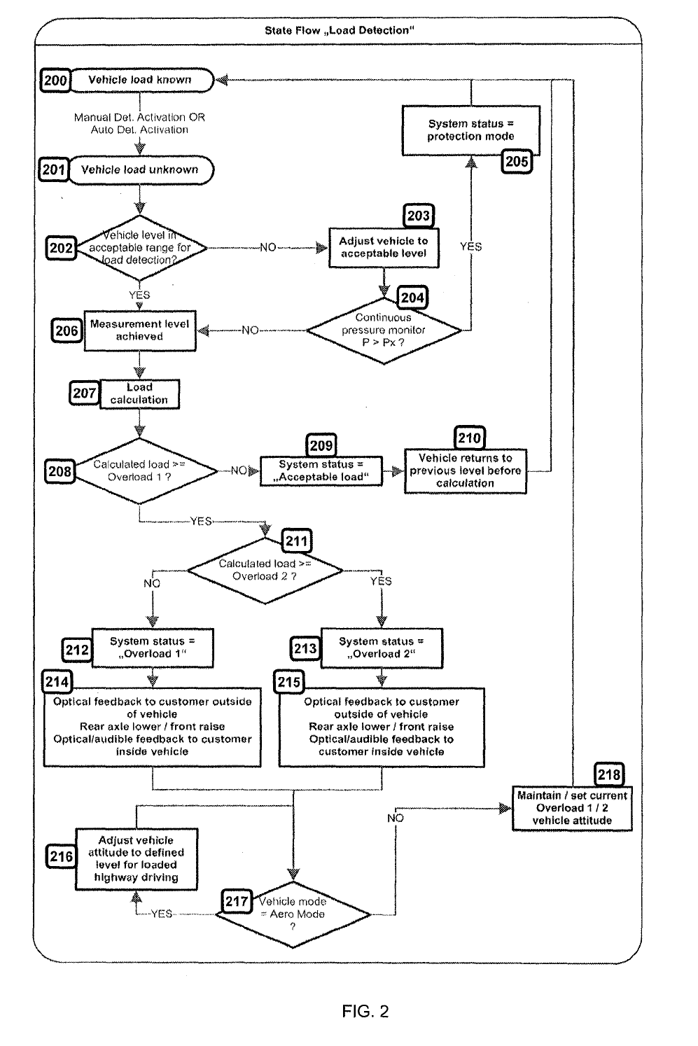

FIG. 2 shows a flow diagram to illustrate the method steps of the method for monitoring the load on vehicle axles having a pneumatic spring system. After vehicle load has changed, the load condition is considered as unknown 201 either due to an automatic detection or a manual trigger.

In order to prevent falsification of the calculation of the weight of the load owing to the weight possibly resting on buffers, the vehicle height is checked 202 and the vehicle level is adjusted 203 in case the vehicle height is outside a defined range. An early check 204 is carried out even in the initial phase of this upward adjustment process to determine whether there is an extreme overload, which might result in damage to the pneumatic springs and/or other components of the chassis if the upward adjustment operation were continued. If a critical overload is detected, the upward adjustment operation is discontinued and the system changes to protection mode 205, thus inhibiting any up-leveling.

If the measurement level was achieved 206, there is no possibility that some of the weight is resting on the buffers. It is only at this measurement level that the weight of the load is calculated 207 from the pressures determined in the pressure sensor 124a. Here too, a check is made to determine whether the load on the vehicle axles is too high. If no overload is detected in method step 208, the load status is considered as acceptable 209, and the vehicle level is adjusted again to a normal level 210.

However, if an overload is detected in method step 208, the load is compared to a second threshold 211, resulting in a load status Overload_{—}1 212 or Overload_{—}2 213. For both overload situations, a warning is created to alert the driver. This can be done by an optical feedback to customer outside the vehicle, e.g. lower the rear/raise the front axle, or by optical/audible feedback to customer inside the vehicle 214, 215.

If the driver ignores all the warning signals and uses the vehicle despite the fact that the vehicle axles are overloaded, the system monitors the vehicle speed and changes to AERO mode 217 in case a speed threshold is exceeded. In AERO mode, the vehicle is adjusted to a defined level 216 which improves the vehicle handling and helps the driver to avoid critical situations. This level will typically be lower than the normal driving level to lower the center of gravity. If the vehicle is not in AERO mode, step 218 is entered.

When the process of load calculation has been finished, the system considers the vehicle load as known 200.

1. A computer-implemented method for monitoring a load on a rear axle and/or a front axle of a chassis, wherein a level control system raises the chassis to a predetermined level by a raising operation after a loading operation and/or after an alteration in a level of the chassis, the method comprises:
a determination of the load on the rear axle and/or the front axle of the chassis, wherein the determination is performed continuously after initiation of the raising operation,
a comparison of the load determined with a predefined limiting value, and
an adaptation of the raising operation if the limiting value is exceeded or undershot.

2. The method according to claim 1, wherein the predetermined level is a measurement level, wherein the measurement level is chosen in such a way that the chassis is raised from buffers of a pneumatic spring system, and wherein the determination of the load on the rear axle and/or the front axle of the chassis is carried out at this measurement level, wherein the level control system lowers the rear axle and/or the front axle as the adaptation of the raising operation if the load on the rear axle and/or the front axle of the chassis exceeds a predefined limiting value, wherein the level control system raises the rear axle and/or the front axle as the adaptation of the raising operation if the load on the rear axle and/or the front axle of the chassis undershoots the predefined limiting value.

3. The method according to claim 2, wherein the determination of the load on the rear axle and/or the front axle of the chassis at the measurement level is performed by a measurement of a pressure in pneumatic springs of the pneumatic spring system, wherein the pressure is proportional to the load and allows calculation of a current load on the rear axle and/or the front axle of the chassis.

4. The method according to claim 3, wherein the determination of the load is carried out even in an initial phase of the raising operation by measuring the pressure in the pneumatic springs of the pneumatic spring system, and the raising of the level of the chassis is discontinued as the adaptation of the raising operation if a predefined limiting value for the load on the rear axle and/or the front axle of the chassis is exceeded.

5. The method according to claim 2, wherein the level control system initially lowers only the rear axle of the chassis if a first predefined limiting value for the load on the rear axle and/or the front axle of the chassis is exceeded.

6. The method according to claim 4, wherein the level control system raises the front axle if an at least second predefined limiting value for the load on the rear axle and/or the front axle of the chassis is exceeded.

7. The method according to claim 2, wherein the level control system lowers the front axle again when a predefined threshold value for a speed of the chassis is reached.

8. The method according to claim 5, wherein an optical and/or acoustic warning signal is set if at least one of the limiting values for the load on the rear axle and/or the front axle of the chassis is exceeded.

9. The method according to claim 1, wherein the method for monitoring the load on the rear axle and/or the front axle of the chassis is activated manually and/or automatically.

10. The method according to claim 1, wherein a current load on the rear axle and/or the front axle of the chassis is indicated optically.

11. The method according to claim 2, wherein the determination of the load on the pneumatic spring system for the entire rear axle and/or the entire front axle is performed by just one pressure sensor.

12. A non-transitory computer program product which comprises instructions that can be executed by a processor and is intended for carrying out the method steps according to claim 1.

13. A monitoring system for monitoring a load on a rear axle and/or a front axle of a chassis, wherein the chassis has a level control system, wherein the level control system is designed to raise the chassis to a predetermined level by means of a raising operation after a loading operation and/or after an alteration in the level of the chassis, wherein the monitoring system is designed for carrying out the following steps:
a determination of the load on the rear axle and/or the front axle of the chassis, wherein the determination is performed continuously after initiation of the raising operation,
a comparison of the load determined with a predefined limiting value, and
an adaptation of the raising operation if the limiting value is exceeded or undershot.

14. The method according to claim 5, wherein the level control system raises the front axle if an at least second predefined limiting value for the load on the rear axle and/or the front axle of the chassis is exceeded.
